(19) United States
(12) Patent Application Publication
(10) Pub. No.: US 2025/0203051 A1
(43) Pub. Date: Jun. 19, 2025

(54) METHODS AND SYSTEMS FOR ARTEFACT CORRECTION OF WARPED IMAGES IN A VIDEO SEE THROUGH DEVICE

(71) Applicant: SAMSUNG ELECTRONICS CO., LTD., Suwon-si (KR)

(72) Inventors: Burra Srihith BHARADWAJ, Bengaluru (IN); Sathyanarayanan Kulasekaran, Bengaluru (IN); Sourav Thakur, Bengaluru (IN); Rudramani Dubey, Bengaluru (IN)

(73) Assignee: SAMSUNG ELECTRONICS CO., LTD., Suwon-si (KR)

(21) Appl. No.: 18/979,129

(22) Filed: Dec. 12, 2024

Related U.S. Application Data
(63) Continuation of application No. PCT/KR2024/016177, filed on Oct. 23, 2024.

(30) Foreign Application Priority Data
Dec. 19, 2023 (IN) 202341086752

(51) Int. Cl. H04N 13/111; G06V 20/20; G06V 20/70; H04N 13/128; H04N 13/243

(52) U.S. Cl. CPC H04N 13/111; G06V 20/20; G06V 20/70; H04N 13/128; H04N 13/243

(57) ABSTRACT

A method of artefact correction of a warped image in a video see through (VST) device including a plurality of primary imaging devices and a plurality of secondary imaging devices, where the method includes: determining a location of at least one artefact and a corresponding depth map from a warped image generated from a plurality of image frames captured by the plurality of primary imaging devices; determining one or more correction parameters for the at least one artefact based on the determined location; identifying image data and corresponding depth information from at least one image frame captured by at least one of the plurality of secondary imaging devices based on the determined location of the at least one artefact and the corresponding depth map; and correcting the at least one artefact in the warped image by applying, based on the correction parameters, the image data to the warped image.

### CROSS-REFERENCE TO RELATED APPLICATION(S)

This application is a continuation application, claiming priority under § 365 (c), of an International application No. PCT/KR2024/016177, filed on Oct. 23, 2024, which is based on and claims the benefit of a India patent application Ser. No. 20/234,1086752, filed on Dec. 19, 2023, in the India Intellectual Property Office, the disclosure of which is incorporated by reference herein in its entirety.

### BACKGROUND

### 1. Field

The present invention relates to Video See Through (VST) devices and image processing, and more particularly relates to methods and systems for artefact correction of a warped image in a VST device.

### 2. Description of Related Art

Video See Through (VST) devices play a crucial role in various fields, offering users the ability to perceive their surroundings by augmenting reality with digital information. These devices, such as Augmented Reality (AR) glasses, provide a live video feed of the user's environment while overlaying computer-generated graphics, data, or information.

In VST devices, passthrough cameras lie a few centimeters in front of the user's eyes which may cause objects to appear closer than they should be. To render a passthrough with accurate depth in the scene, a warping/view synthesis of stereo images may be necessary. Upon warping, the image may exhibit artefacts known as disocclusions, representing vacant areas where scene information, intended to be visible to the user's eyes, may be obscured in the passthrough cameras' view and require filling. To fill this region of the image, various solutions (such as inpainting) have been proposed that fill said artefacts using surrounding information. However, if the occluded region is beyond a certain width, such solutions may lead to poor results. Also, such conventional solutions fail to fill such disocclusions in many scenarios where the surrounding information is insufficient.

### SUMMARY

This summary is provided to introduce a selection of concepts, in a simplified format, that are further described in the detailed description of the invention. This summary is neither intended to identify key or essential inventive concepts of the invention nor is it intended for determining the scope of the invention.

According to an aspect of the disclosure, provided is a method of artefact correction of a warped image in a video see through (VST) device including a plurality of primary imaging devices and a plurality of secondary imaging devices, the method may include: determining a location of at least one artefact and a corresponding depth map from a warped image generated from a plurality of image frames captured by the plurality of primary imaging devices; determining one or more correction parameters for the at least one artefact based on the determined location; identifying image data and corresponding depth information from at least one image frame captured by at least one of the plurality of secondary imaging devices based on the determined location of the at least one artefact and the corresponding depth map; and correcting the at least one artefact in the warped image by applying, based on the one or more correction parameters, the image data to the warped image.

The method may further include, prior to correcting the at least one artefact in the warped image, modifying the image data based on the one or more correction parameters, where the one or more correction parameters include at least one of a resolution, a sharpness, a colour, and a luma component.

The identifying the image data from the at least one image frame captured by the at least one of the plurality of secondary imaging devices may include: identifying at least one region from the at least one image frame based on the determined location of the at least one artefact in the warped image and the one or more correction parameters.

The correcting the at least one artefact in the warped image may include: generating a scene at the determined location of the at least one artefact by fusing the image data from the at least one image frame with the warped image.

The determining the location of the at least one artefact in the warped image may include: identifying a plurality of blank pixels and corresponding position coordinates in the warped image; classifying the plurality of blank pixels as the at least one artefact; and determining the location of the at least one artefact based on the position coordinates of the plurality of blank pixels.

The identifying the image data from the at least one image frame captured by the at least one of the plurality of secondary imaging devices may include: receiving a plurality of image frames captured by the plurality of secondary imaging devices; selecting the at least one image frame from the plurality of image frames based on the determined location of the at least one artefact and the one or more correction parameters; and identifying the image data from the at least one image frame.

The identifying the image data from the at least one image frame captured by the at least one of the plurality of secondary imaging devices may include: selecting at least one of the plurality of secondary imaging devices based on the determined location of the at least one artefact and the one or more correction parameters; and identifying the image data from the at least one image frame captured by the at least one selected secondary imaging device.

The method may further include: determining the depth map including a depth value for a plurality of pixels from an image captured by one of the plurality of secondary imaging devices and corresponding to the warped image.

According to an aspect of the disclosure, provided is a system for artefact correction of a warped image in a video see through (VST) device, the system may include: a plurality of primary imaging devices; a plurality of secondary imaging devices; a memory storing instructions; and at least one processor communicably coupled with the memory, where, by executing the instructions stored on the memory, the at least one processor is configured to: determine a location of at least one artefact and a corresponding depth map from a warped image generated from a plurality of image frames captured by the plurality of primary imaging devices; determine one or more correction parameters for the at least one artefact based on the determined location; identify image data and corresponding depth information from at least one image frame captured by at least one of the plurality of secondary imaging devices based on the determined location of the at least one artefact and the corresponding depth map; and correct the at least one artefact in the warped image by applying, based on the one or more correction parameters, the image data to the warped image.

In correcting the at least one artefact in the warped image, the at least one processor may be configured to: modify the image data based on the one or more correction parameters, where the one or more correction parameters comprise at least one of a resolution, a sharpness, a colour, and a luma component.

In identifying the image data from the at least one image frame captured by the at least one of the plurality of secondary imaging devices, the at least one processor may be configured to: identify at least one region of the at least one image frame based on the determined location of the at least one artefact in the warped image and the one or more correction parameters.

In correcting the at least one artefact in the warped image, the at least one processor is configured to: generate a scene at the determined location of the at least one artefact by fusing the image data from the at least one image frame with the warped image.

In determining the location of the at least one artefact in the warped image, the at least one processor may be configured to: identify a plurality of blank pixels and corresponding position coordinates in the warped image; classify the plurality of blank pixels as the at least one artefact; and determine the location of the at least one artefact based on the position coordinates of the plurality of blank pixels.

In identifying the image data from the at least one image frame captured by the at least one of the plurality of secondary imaging devices, the at least one processor may be configured to: receive a plurality of image frames captured by the plurality of secondary imaging devices; select the at least one image frame from the plurality of image frames based on the determined location of the at least one artefact and the one or more correction parameters; and identify the image data from the at least one image frame.

In identifying the image data from the at least one image frame captured by the at least one of the plurality of secondary imaging devices, the at least one processor may be configured to: select at least one of the plurality of secondary imaging devices based on the determined location of the at least one artefact and the one or more correction parameters; and identify the image data from the at least one image frame captured by the at least one selected secondary imaging device.

The plurality of primary imaging devices may include a plurality of red-green-blue (RGB) cameras, where the plurality of secondary imaging devices include a plurality of simultaneous localization and mapping (SLAM) cameras, and where, based on an arrangement of the plurality of SLAM cameras relative to the plurality of RGB cameras, the plurality of SLAM cameras are configured to capture a region not within a field of view of the plurality of RGB cameras.

The at least one processor may be further configured to: determine the depth map including a depth value for a plurality of pixels from an image captured by one of the plurality of secondary imaging devices and corresponding to the warped image.

According to an aspect of the disclosure, provided is a non-transitory computer-readable recording medium in which a program for executing an artefact correction method of a video see through (VST) device comprising a plurality of primary imaging devices and a plurality of secondary imaging devices, the artefact correction method may include: determining a location of at least one artefact and a corresponding depth map from a warped image generated from a plurality of image frames captured by the plurality of primary imaging devices; determining one or more correction parameters for the at least one artefact based on the determined location; identifying image data and corresponding depth information from at least one image frame captured by at least one of the plurality of secondary imaging devices based on the determined location of the at least one artefact and the corresponding depth map; and correcting the at least one artefact in the warped image by applying, based on the one or more correction parameters, the image data to the warped image.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 illustrates a process flow for correcting artefacts, according to a technique in a related art;

FIG. 2 illustrates disocclusions as occurred in Video See Through (VST) devices, according a related art;

FIG. 3 illustrates an exemplary environment of a system for artefact correction of a warped image in a VST device, according to an embodiment of the present disclosure;

FIG. 4 illustrates a schematic block diagram of the system, according to an embodiment of the present disclosure;

FIG. 5 illustrates a process flow for artefact correction, according to an embodiment of the present disclosure;

FIG. 6 illustrates an exemplary scenario of image wrapping in the VST device, according to an embodiment of the present disclosure;

FIG. 7 illustrates an exemplary scenario of depth estimation and pixel correspondence, according to an embodiment of the present disclosure;

FIG. 8 illustrates a schematic representation of artefact detection and correction, according to an embodiment of the present disclosure;

FIG. 9 illustrates an exemplary scenario of a selection of a secondary imaging device for artefact correction, according to an embodiment of the present disclosure;

FIG. 10 illustrates an exemplary scenario of post-processing, according to an embodiment of the present disclosure;

FIG. 11 illustrates an exemplary scenario of an importance of depth estimation, according to an embodiment of the present disclosure; and

FIG. 12 illustrates a flow chart depicting a method for artefact correction of the warped image in the VST device, according to an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

For the purpose of promoting an understanding of the principles of the invention, reference will now be made to the various embodiments and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates. The same reference numerals are used for the same components in the drawings, and redundant descriptions thereof will be omitted. It is to be understood that singular forms include plural referents unless the context clearly dictates otherwise. The terms including technical or scientific terms used in the disclosure may have the same meanings as generally understood by those skilled in the art.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “include,” “including,” “have,” “having,” “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components preceded by “comprises . . . a” does not, without more constraints, preclude the existence of other devices or other sub-systems or other elements or other structures or other components or additional devices or additional sub-systems or additional elements or additional structures or additional components.

As used herein, each of the expressions “A or B,” “at least one of A and B,” “at least one of A or B,” “A, B, or C,” “at least one of A, B, and C,” and “at least one of A, B, or C,” may include one or all possible combinations of the items listed together with a corresponding expression among the expressions.

The present disclosure is directed to a method for artefact correction of a warped image in a VST device. The method may implement simultaneous localization and mapping (SLAM) cameras to fill disocclusions in the warped image accurately. Further, the method may include enhancing regions in images from the SLAM cameras that are used for artefact correction to accurately fill the disocclusion in the warped image. Further, the method may include utilizing a light weight Artificial Intelligence (AI) model to identify artefacts in the warped image, determine regions for artefact correction in images from the SLAM camera, enhance the determined regions, and correct the artefacts in the warped image. Moreover, the method may include reconstructing a complete scene of an environment by fusion of images from the SLAM cameras.

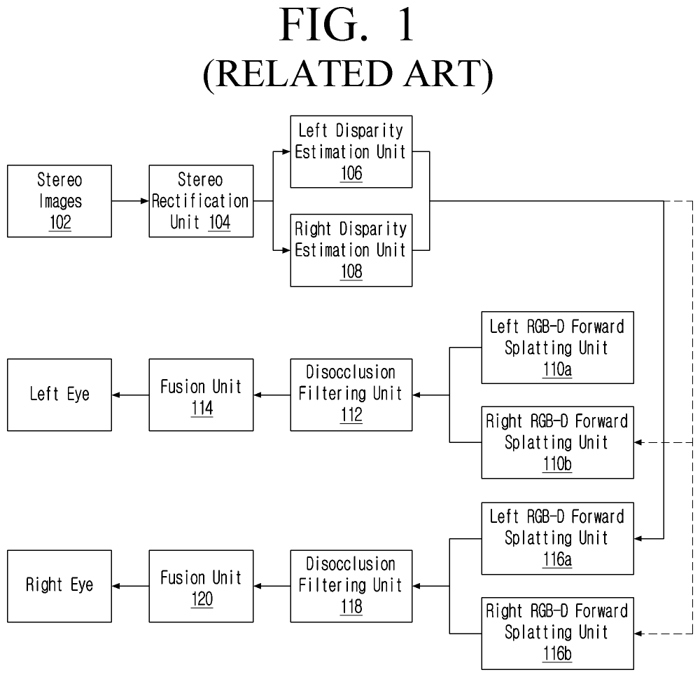

FIG. 1 illustrates a process flow for correcting artefacts, according to a technique of a related art. At block 102, at least a pair of stereo images may be received, as input. The pair of stereo images may be captured by primary camera devices of a VST device from different perspectives than that of human eyes. The pair of stereo images may create a three-dimensional (3D) effect. The pair of stereo images may be captured and displayed in a manner that creates an immersive and realistic visual experience for a user. Next, a stereo rectification unit 104 may adjust and align the pair of stereo images to create a representation of a 3D environment. The stereo rectification unit 104 may perform functions such as, line alignment, disparity map calculation, depth perception, image pairing, etc. Thereafter, left and right disparity estimation units 106, 108, respectively may calculate a disparity map from the pair of stereo images. The disparity map may be defined as pixel-wise differences between corresponding points in the pair of stereo images (i.e., a left image and a right image) captured by the primary camera device (stereo cameras). The left and right disparity estimation units 106, 108 may also perform depth estimation and scene reconstruction based on the estimated disparity in the pair of stereo images.

Thereafter, a left and a right RGB-D forward splatting unit 110a and 110b for the left eye of the user, and a left and a right RGB-D forward splatting unit 116a and 116b of the user may implement a forward splatting technique to project and render 3D components of the environment onto a 2D image space for each of the left and right eye, respectively. Next, a disocclusion filtering unit 112 for the left eye and a disocclusion filtering unit 118 for the right eye may identify disocclusion in the pair of stereo images and use the images to filter said disocclusion in one image among the pair of stereo images using information from the other image among the pair of stereo images. Thus, the disocclusion filtering units 112 and 118 may try to maintain visual consistency in the rendered images. Lastly, a fusion unit 114 for the left eye and a fusion unit 120 for the right eye may combine and integrate information from various units and create a comprehensive and cohesive representation of the environment. Thus, the solutions of the related art may perform partial disocclusion filtering that only utilizes the primary/RGB camera devices of the VST device. Further, in the solutions of the related art, remaining artefacts may be corrected using the inpainting technique. Thus, the conventional solutions may fail to fully remove the artefacts in the stereo images leading to poor user experience.

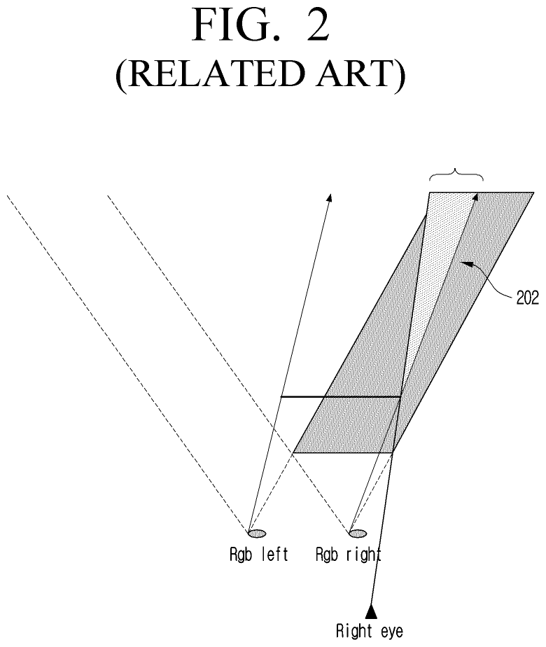

FIG. 2 illustrates disocclusions as occurred in Video See Through (VST) devices, according to the related art. As illustrated, a region 202 which might be visible to the user's eyes is occluded due to a field of view of the primary camera devices (also referred to as passthrough cameras) of the VST device.

Accordingly, there is a need for a solution to overcome the above-mentioned problems associated with the wrapped images and associated disocclusions in the VST devices.

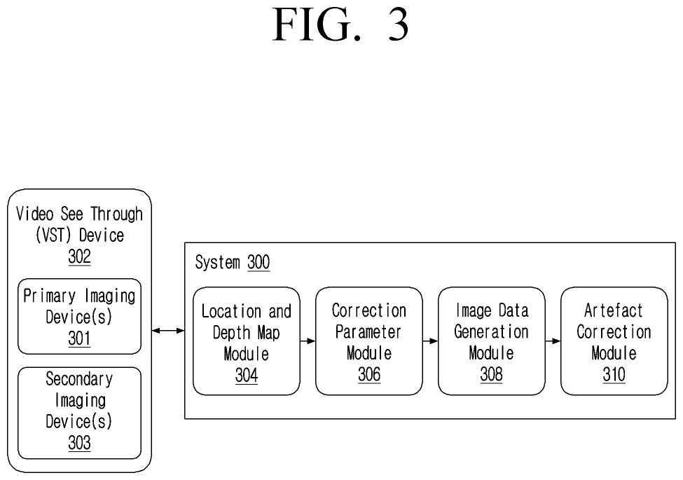

FIG. 3 illustrates an exemplary environment of a system 300 for artefact correction of a warped image in a VST device 302, according to an embodiment of the present disclosure. The VST device 302 may allow users to visualize a physical environment surrounding the users while simultaneously overlaying virtual or computer-generated information onto that real-world view. Applications of the VST device 302 may include, but are not limited to, gaming, navigation, industrial training, medical visualization, and various other scenarios in which merging digital content with the real world enhances the user experience. The VST device 302 may include a plurality of primary imaging devices 301 and a plurality of secondary imaging devices 303. The plurality of primary imaging devices 301 may include a pair of cameras for each of the human eyes, i.e., a left eye and a right eye. Further, the primary imaging devices 301 may also be referred to as passthrough cameras. The second imaging devices 303 may include a plurality of simultaneous localization and mapping (SLAM) cameras placed in the surroundings of the primary imaging devices 301. The VST device 302 may further include other essential standard components such as, a display, a speaker, a processor, a memory, and one or more other sensors. However, a detailed description of such components is omitted.

In one embodiment, the system 300 may be a standalone entity which is communicably coupled to the VST device 302 via a network. In another embodiment, the system 300, either in-part or as a whole, may be implemented at the VST device 302. The VST device 302 may be configured to generate a plurality of image frames captured by the primary imaging devices 301 and/or the secondary imaging devices 303. The system 300 may be communicably connected with the VST device 302 and configured to receive the plurality of image frames as captured by the primary imaging devices 301 and/or the secondary imaging devices 303 of the VST device 302. In an embodiment, the VST device 302 may be configured to generate the warped image from the plurality of image frames as captured by the primary imaging devices 301 and/or the secondary imaging devices 303 and share the generated warped image with system 300.

The system 300 may include a location and depth map module 304 that is configured to determine a location of one or more artefacts and corresponding depth map(s) from the warped image. The artefact may correspond to a region in the warped image that does not include valid pixel information and/or any pixel information. The corresponding depth map may indicate the position of said region and/or the artefact in a 2D space. In one embodiment, the location and depth map module 304 may be configured to identify a plurality of blank pixels and corresponding position coordinates in the warped image. The location and depth map module 304 may classify the identified plurality of blank pixels as the one or more artefacts in the warped image. Further, the location and depth map module 304 may be configured to determine the location of the one or more artefacts based on the position coordinates of the plurality of blank pixels.

The system 300 may further include a correction parameter module 306 that is configured to determine one or more correction parameters for the one or more artefacts based on the determined location of said one or more artefacts. Examples of the one or more correction parameters may include, but are not limited to, a resolution, a colour, sharpness, luma, etc. The correction parameter module 306 may analyze an environment in the warped image and the one or more artefacts to determine the one or more correction parameters.

The system 300 may further include an image data generation module 308. The image data generation module 308 may be configured to identify image data along with corresponding depth information from one or more image frames generated by the plurality of secondary imaging devices 303. The image data generation module 308 may generate the image data based on the determined location of the one or more artefacts and the corresponding depth map. In one embodiment, the image data may correspond to a region in one of the image frames among the plurality of image frames generated by the plurality of secondary imaging devices 303 that correspond to disocclusion/artefact in the warped image. The image data may correspond to a region of the environment that the plurality of primary imaging devices 301 fail to capture due to a limited field of view of said plurality of primary imaging devices 301.

The image data generation module 308 may be configured to select at least one of the plurality of secondary imaging devices 303 based on the determined location of the one or more artefacts and the one or more correction parameters. Further, the image data generation module 308 may identify the image data from the one or more image frames captured by the selected at least one of the plurality of secondary imaging devices 303. Thus, the image data generation module 308 may reduce processing complexity and enhance the overall performance of the system 300 by effectively selecting one or more secondary imaging devices 303 among the plurality of secondary imaging devices 303.

The system 300 may further include an artefact correction module 310. The artefact correction module 310 may be configured to apply the image data on the warped image to correct the one or more artefacts in the warped image. In one embodiment, the image data may include a plurality of regions from the image frames captured by the plurality of secondary imaging devices 303 to correct the one or more artefacts in the warped image. Each region among the plurality of regions may be used to correct a corresponding artefact in the warped image. In one embodiment, the artefact correction module 310 may apply the image data based on the one or more correction parameters.

The artefact correction module 310 may further be configured to modify the image data based on the one or more correction parameters. The artefact correction module 310 may modify the image data with the warped image. In one embodiment, the artefact correction module 310 may be configured to fuse the image data from the one or more image frames with the warped image to generate a scene at the determined location of an artefact among the one or more artefacts.

Thus, the system 300 may enable accurate filling of artefacts in the warped images to get realistic views for the user using the secondary imaging devices 303 of the VST device 302.

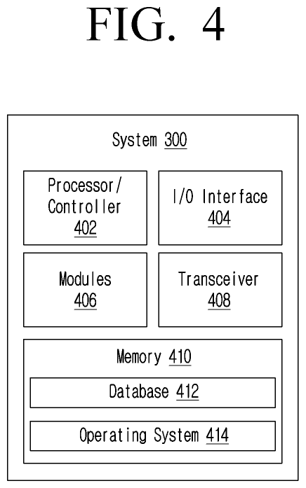

FIG. 4 illustrates a schematic block diagram of the system 300, according to an embodiment of the present disclosure. The system 300 may include a processor/controller 402, an Input/Output (I/O) interface 404, one or more modules 406, a transceiver 408, and a memory 410. In an exemplary embodiment, the processor/controller 402 may be operatively coupled to each of the I/O interface 404, the modules 406, the transceiver 408, and the memory 410.

In one embodiment, the processor/controller 402 may include at least one data processor for executing processes in the Virtual Storage Area Network. The processor/controller 402 may include specialized processing units such as integrated system (bus) controllers, memory management control units, floating point units, graphics processing units, digital signal processing units, etc. In one embodiment, the processor/controller 402 may include a Central Processing Unit (CPU), a Graphics Processing Unit (GPU), or both. The processor/controller 402 may be one or more general processors, Digital Signal Processors (DSPs), Application-Specific Integrated Circuits (ASIC), Field-Programmable Gate Arrays (FPGAs), servers, networks, digital circuits, analog circuits, combinations thereof, or other now known or later developed devices for analyzing and processing data. The processor/controller 402 may execute a software program, such as code generated manually (i.e., programmed) to perform the desired operation.

The processor/controller 402 may be disposed in communication with one or more I/O devices via the I/O interface 404. The I/O interface 404 may employ communication Code-Division Multiple Access (CDMA), High-Speed Packet Access (HSPA+), Global System for Mobile communications (GSM), Long-Term Evolution (LTE), Worldwide interoperability for Microwave Access (WiMAX), or the like, etc.

Using the I/O interface 404, the system 300 may communicate with one or more I/O devices, specifically, to the VST device 302. Other examples of the input device may be an antenna, microphone, touch screen, touchpad, storage device, transceiver, video device/source, etc. The output devices may be a printer, fax machine, video display (e.g., Cathode Ray Tube (CRT), Liquid Crystal Display (LCD), Light-Emitting Diode (LED), plasma, Plasma Display Panel (PDP), Organic Light-Emitting Diode display (OLED) or the like), audio speaker, etc.

The processor/controller 402 may be disposed in communication with a communication network via a network interface. In an embodiment, the network interface may be the I/O interface 404. The network interface may connect to the communication network to enable connection of the system 300 with the outside environment and/or device/system. The network interface may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. The communication network may include, without limitation, a direct interconnection, Local Area Network (LAN), Wide Area Network (WAN), wireless network (e.g., using Wireless Application Protocol), the internet, etc. Using the network interface and the communication network, the system 300 may communicate with other devices.

In an exemplary embodiment, the processor/controller 402 may be configured to determine a location of at least one artefact and a corresponding depth map from the warped image. The warped image may be generated from a plurality of image frames captured by the plurality of primary imaging devices 301. The processor/controller 402 may be further configured to determine one or more correction parameters for the at least one artefact based on the corresponding determined location. Further, the processor/controller 402 may be configured to identify image data along with corresponding depth information from at least one image frame generated by at least one of the plurality of secondary imaging devices 303 based on the determined location of the at least one artefact and the corresponding depth map. Further, the processor/controller 402 may be configured to apply the image data on the warped image to correct the at least one artefact in the warped image based on the one or more correction parameters.

The processor/controller 402 may implement various techniques such as, but not limited to, data extraction, Artificial Intelligence (AI), Machine Learning (ML), Deep Learning (DL), and the like, to achieve the desired objective.

In some embodiments, the memory 410 may be communicatively coupled to the at least one processor/controller 402. The memory 410 may be configured to store data, and instructions executable by the at least one processor/controller 402. The memory 410 may communicate via a bus within the system 300. The memory 410 may be implemented as one or more memories. For instance, the memory 410 may include, but not limited to, a non-transitory computer-readable storage media, such as various types of volatile and non-volatile storage media including, but not limited to, Random Access Memory (RAM), Read-Only Memory (ROM), Programmable Read-Only Memory (PROM), electrically Programmable ROM, electrically erasable ROM, flash memory, magnetic tape or disk, optical media, and the like. In one example, the memory 410 may include a cache or random-access memory for the processor/controller 402. In alternative examples, the memory 410 is separate from the processor/controller 402, such as a cache memory of a processor, the system memory, or other memory. The memory 410 may be an external storage device or database for storing data. The memory 410 may be operable to store instructions executable by the processor/controller 402. The functions, acts, or tasks illustrated in the figures or described may be performed by the programmed processor/controller 402 for executing the instructions stored in the memory 410. The functions, acts or tasks are independent of the particular type of instruction set, storage media, processor or processing strategy and may be performed by software, hardware, integrated circuits, firmware, micro-code, and the like, operating alone or in combination. Likewise, processing strategies may include multiprocessing, multitasking, parallel processing, and the like.

In some embodiments, the modules 406 may be included within the memory 410. The memory 410 may further include a database 412 to store data. The one or more modules 406 may include a set of instructions that may be executed to cause the system 300 to perform any one or more of the methods/processes disclosed herein. In an embodiment, the modules 304, 306, 308, and 310 (as shown in FIG. 3) may be included in the modules 406. The modules 406 may be configured to perform the steps of the present disclosure based on the data stored in the database 412, for performing the desired objective of the present disclosure as discussed herein. In an embodiment, each of the modules 406 may be a hardware unit that may be outside the memory 410. Further, the memory 410 may include an operating system 414 for performing one or more tasks of the system 300, as performed by a generic operating system in the communications domain. The transceiver 408 may be configured to receive and/or transmit signals to and from the VST device 302 associated with the user. In one embodiment, the database 412 may be configured to store the information as required by the one or more modules 406 and the processor/controller 402 to perform one or more desired functions.

Further, according to an embodiment, a computer-readable medium may include instructions or receive and execute instructions responsive to a propagated signal. Further, the instructions may be transmitted or received over the network via a communication port or interface or using a bus. The communication port or interface may be included the processor/controller 402 or may be a separate component. The communication port may be created in software or may be a physical connection in hardware. The communication port may be configured to connect with a network, external media, the display, or any other components in the system, or combinations thereof. The connection with the network may be a physical connection, such as a wired Ethernet connection, or may be established wirelessly. Likewise, the additional connections with other components of the system 300 may be physical or may be established wirelessly. The network may alternatively be directly connected to the bus. For the sake of brevity, the architecture, and standard operations of the operating system 414, the memory 410, the database 412, the processor/controller 402, the transceiver 408, and the I/O interface 404 are not discussed in detail.

The one or a plurality of processors may control the processing of the input data in accordance with a predefined operating rule or Artificial Intelligence (AI) model stored in the non-volatile memory and the volatile memory. The predefined operating rule or AI model may be provided through training or learning.

Here, being provided through learning means that, by applying a learning technique to a plurality of learning data, a predefined operating rule or AI model of the desired characteristic is made. The learning may be performed in a device itself in which AI according to an embodiment is performed, and/or may be implemented through a separate server/system.

The AI model may include a plurality of neural network layers. Each layer may have a plurality of weight values and perform a layer operation through the calculation of a previous layer and an operation of a plurality of weights. Examples of neural networks include, but are not limited to, Convolutional Neural Network (CNN), Deep Neural Network (DNN), Recurrent Neural Network (RNN), Restricted Boltzmann Machine (RBM), Deep Belief Network (DBN), Bidirectional Recurrent Deep Neural Network (BRDNN), Generative Adversarial Networks (GAN), and deep Q-networks.

The learning technique is a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, or reinforcement learning.

According to one or more embodiments, in a method for artefact correction of a warped image in a VST device, the method may include using an artificial intelligence model to recommend/execute the plurality of instructions. The processor may perform a pre-processing operation on the data to convert the data into a form appropriate for use as an input for the AI model. The AI model may be obtained by training. Here, “obtained by training” means that a predefined operation rule or AI model configured to perform the desired feature (or purpose) is obtained by training a basic AI model with multiple pieces of training data by a training technique. The AI model may include a plurality of neural network layers. Each of the plurality of neural network layers may include a plurality of weight values and perform neural network computation by computation between a result of computation by a previous layer and the plurality of weight values.

Reasoning prediction is a technique of logical reasoning and predicting by determining information including, e.g., knowledge-based reasoning, optimization prediction, preference-based planning, or recommendation.

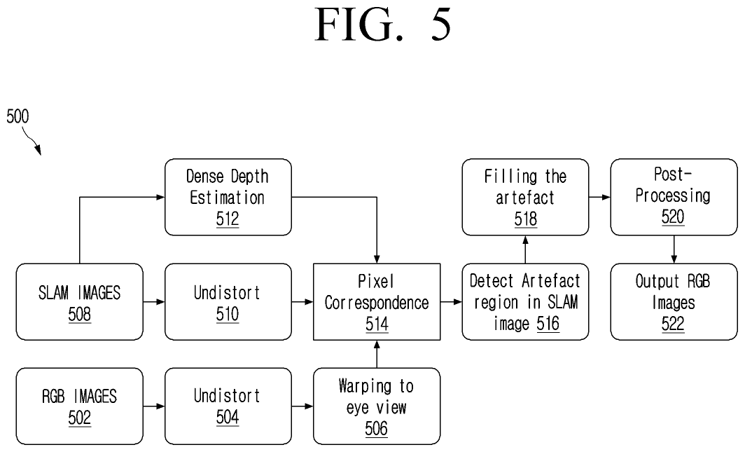

FIG. 5 illustrates a process flow 500 for artefact correction, according to an embodiment of the present disclosure. The process flow 500 may be implemented by one or more components of the system 300.

At block 502, a plurality of Red Green Blue (RGB) images may be received by the system 300. The RGB images may correspond to a plurality of images captured by the plurality of primary imaging devices 301. In an exemplary embodiment, the RGB images may be captured by a pair of primary imaging devices 301 in which the pair of primary imaging devices may be configured to capture an environment from a field of view of the pair of eyes of the user.

At block 504, the system 300 may undistort the received plurality of RGB images. The system 300 may remove distortion(s) from the received plurality of RGB images. Such distortions may be a result of factors such as, but not limited to, lens imperfections, alignment errors, wide field-of-view cameras. Further, the system 300 may follow a generic distortion removal process including identification of a type of distortion, pre-processing of images, and removal of distortion based on the identified type of distortion. The system 300 may implement distortion removal techniques such as, but not limited to, lens distortion correction, chromatic aberration correction, perspective correction, fine-tuning, and so forth. The system 300 may also post-process the images after performing the distortion removal process.

At block 506, the system 300 may warp the plurality of RGB images in accordance with the field of view of the eyes of the user. The system 300 may be configured to transform/manipulate the RGB images in order to correct optical distortion and align the RGB images with the user's perspective. The system 300 may implement the warping techniques in real-time to give an immersive experience in a virtual and/or mixed-reality environment. The warping techniques may ensure that virtual and real-world elements are visually integrated in a coherent and natural way, enhancing the user's immersion and interaction with the mixed-reality environment.

At block 508, the system 300 may receive a plurality of SLAM images from the plurality of secondary imaging devices 303. The SLAM images may be a different field of view as compared to the RGB images. In some embodiments, the plurality of secondary imaging devices 303 may be placed in the surroundings of the primary imaging devices 301 such that the secondary imaging devices 303 may capture regions of the environment which are not in the field of view of the primary imaging devices 301.

At block 510, the system 300 may undistort the received plurality of SLAM images. The system 300 may implement similar techniques/processes to undistort the plurality of SLAM images, as discussed in view of block 504 for the RGB images.

At block 512, the system 300 may perform dense depth estimation on the plurality of SLAM images received at block 508. The system 300 may calculate depth information for each pixel in each of the SLAM images to create a depth map that represents the spatial layout of the scene/environment. In one embodiment, the system 300 may perform pixel-wise depth calculation that assigns a depth value to each pixel in the input image. The depth map may correspond to a detailed and continuous representation of the environment's 3D structure. The depth map may be a greyscale in which lighter pixels may indicate objects/components that are closer to the imaging device, and darker pixels may indicate objects/components that are farther away from the imaging device. However, the assignment of the depth value to each pixel may vary based on the requirement of the application. The system 300 may implement various techniques such as, but not limited to, monocular depth estimation, stereo matching, and so forth, to identify and generate the depth maps corresponding to the input SLAM images.

At block 514, the system 300 may perform pixel correspondence in the plurality of SLAM images and the warped image. The system 300 may identify corresponding points/pixels in the plurality of SLAM images and the warped image to establish a pixel correspondence. By performing the pixel correspondence, the system 300 may associate a pixel/point from one or more of the plurality of SLAM images with the corresponding pixel/point in the warped image. The system 300 may perform the pixel correspondence to identify artefacts in the warped image. Next at block 516, the system 300 may identify artefact regions in the plurality of SLAM images based on the performed pixel correspondence. The system 300 may identify the regions from the plurality of SLAM images that can be used to correct artefacts and/or fill disocclusions in the warped image.

At block 518, the system 300 may fill the artefact and/or disocclusions in the warped image based on the identified regions from the plurality of SLAM images. At block 520, the system 300 may perform the post-processing of the corrected warped image. The system 300 may perform the post-processing of the corrected warped image to enhance, correct, or modify the characteristics of the corrected warped image and improve overall user experience of the VST device 302. Examples of techniques that may be implemented by the system 300 as a post-processing step may include, but are not limited to, noise reduction, contrast adjustment, color correction, sharpening, image filtering, image resizing and cropping, image fusion, image annotation, resolution enhancement, and so forth.

At block 522, the system 300 may output and/or render the corrected warped image. The various steps explained in reference to FIG. 5 may be performed by the processor/controller 402 and/or the one or more modules 406 of the system 300.

Thus, the system 300 may be able to effectively fill the artefact in the warped image using the plurality of secondary imaging devices 303. The secondary imaging devices 303 may be placed in a manner to capture the regions of the environment that may be viewed to the naked eye of the user but are not in the field of view of the primary imaging devices 301. Generally, the secondary imaging devices 303 are multiple in number and the VST device 302 may have at least two secondary imaging devices 303. Further, the secondary imaging device 303 may enable both horizontal and vertical disocclusion filtering by effective placement on the VST device 302.

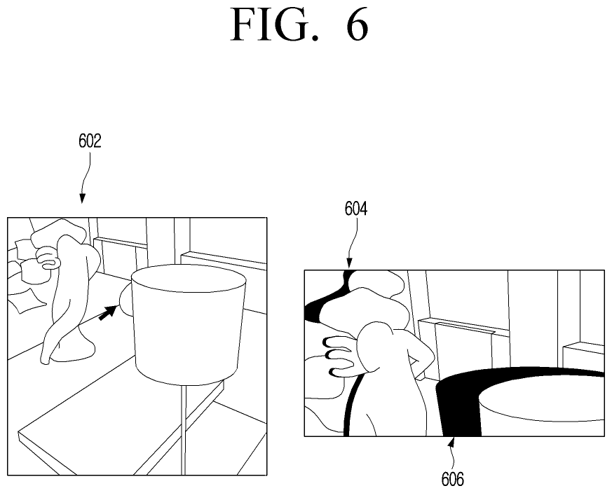

FIG. 6 illustrates an exemplary scenario of image wrapping in the VST device 302, according to an embodiment of the present disclosure. Here, an image 602 may be captured by the primary imaging device 301 of the VST device 302. The system 300 may receive the image 602 and a corresponding depth map, as input. On successful warping of the image 602 based on the corresponding depth map and a desired target eye viewpoint, a warped image 604 may be generated by the system 300. In one embodiment, the system 300 may implement a forward warping technique to generate the warped image 604. However, the forward warping technique is prone to introduction of holes in the image due to disocclusion as multiple source pixels may be mapped to the same pixel in a warped image space. Thus, an artefact region 606 may be introduced in the warped image 604. In one embodiment, the system 300 may implement a neural network to reconstruct a colour image and/or the warped image 604 at each target eye viewpoint to provide stereo views to the user. However, multiple pixels may map to the same location leading to the introduction of the artefact region 606. The system 300 may effectively generate a depth map corresponding to the artefact 606 and determine a location corresponding to the artefact region 606.

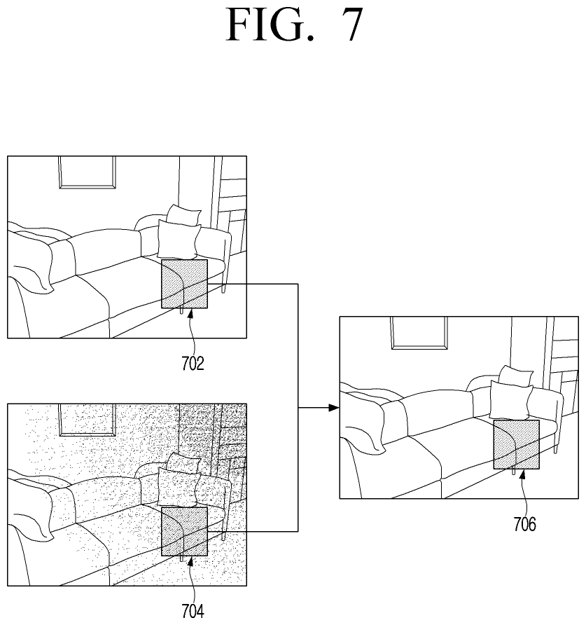

FIG. 7 illustrates an exemplary scenario of depth estimation and pixel correspondence, according to an embodiment of the present disclosure. The system 300 may receive the RGB images and the SLAM images, as input. The system 300 may calibrate the passthrough cameras (i.e., the primary imaging devices 301) and the SLAM cameras (i.e., the secondary imaging devices 303) prior to performing the depth estimation and pixel correspondence. In one embodiment, the system 300 may generate the depth map of the environment/scene using the SLAM cameras. Thus, based on depth values generated as a part of the depth map and the calibrated SLAM and passthrough cameras, the system 300 may easily identify any region of the passthrough images (i.e., the images captured by the passthrough cameras) in the SLAM images (i.e., the images captured by the SLAM cameras). For instance, as illustrated, a region 702 in the passthrough image in conjunction with a region 704 in the depth map is easily identified in the SLAM image as a region 706. In one embodiment, the system 300 may implement an inverse triangulation technique to find a depth of a scene/environment using two or more calibrated cameras and perform pixel correspondence in the images captured by such calibrated cameras. By performing pixel correspondence using the above-mentioned technique, the system 100 may detect even a tiny patch of the passthrough image in the SLAM image.

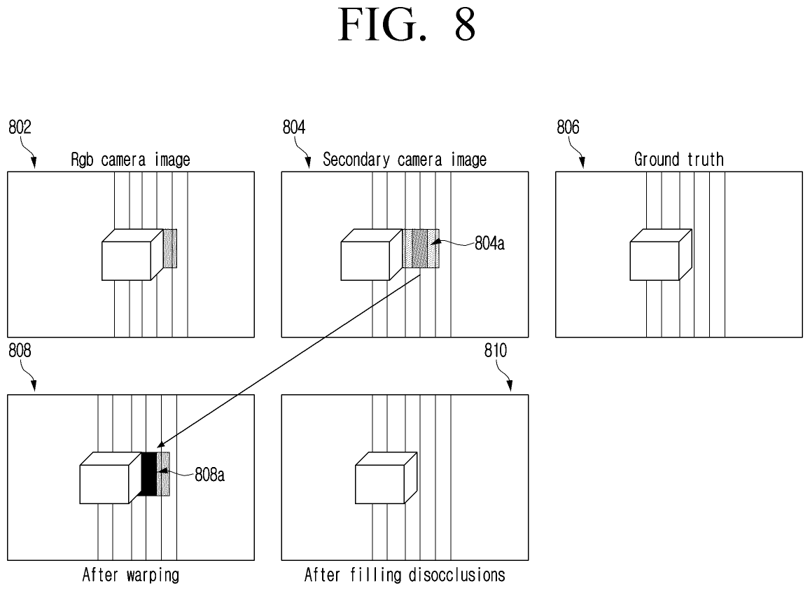

FIG. 8 illustrates a schematic representation of artefact detection and correction, according to an embodiment of the present disclosure. Here, block 802 may represent an RGB image corresponding to an environment that may be captured by an RGB camera (i.e., the primary imaging device 301). Block 804 may represent a secondary image/SLAM image corresponding to the environment that may be captured by the secondary imaging device 303/SLAM camera. Block 806 may represent a real eye-view image and/or ground truth of the environment. Block 808 may represent a warped image generated based on the RGB image and corresponding depth image. As illustrated, the system 300 may identify a region 808a, as an artefact in the warped image 808. The system 300 may perform pixel correspondence in the RGB image 802 and the secondary image 804 to identify a region 804a in the secondary image 804 to fill the artefact 808a in the warped image 808. Other highlighted regions in the secondary image 804 may be considered as additional information. Further, based on the identified region 804a, the system 300 may fill the artefact 808a and generate a corrected image, as represented by block 810. In an embodiment, the system 300 may perform a complete image synthesis process to fill the identified artefact 808a with the identified region 804a. Thus, the system 300 effectively identifies the region from the secondary image 804 to correct the artefact in the warped image 808.

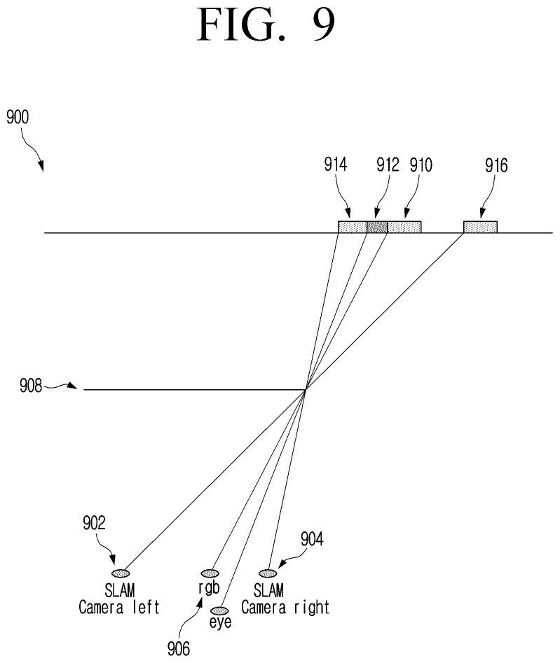

FIG. 9 illustrates an exemplary scenario 900 of a selection of a secondary imaging device (SLAM camera) for artefact correction, according to an embodiment of the present disclosure. In the illustrated embodiment, the VST device may include two SLAM cameras namely, a SLAM camera left 902 and a SLAM camera right 904. Further, as shown, a RGB camera 906 of the VST device may not be able to capture regions 914 and 912 due to the presence of a foreground object 908. However, a human eye with the VST device may be able to view the region 912 as well as region 910. Also, the SLAM camera right 904 may be able to capture regions 914, 912, and 910. The SLAM camera left 902 may only be able to capture region 916. Thus, in order to correct artefact due to the foreground object 908, the system 300 (as also explained with reference to in FIG. 3) may select the images from the SLAM camera right 904 to effectively fill the disocclusion in a warped image. If an artefact occurs on the right side of the foreground object 908, the SLAM camera right 904 may be used. Also, if there are multiple SLAM cameras placed on the right side of the foreground object 908, the images from said multiple SLAM cameras may be used to correct the artefacts in the warped image. In such a case, the system 300 may fuse the images from the multiple SLAM cameras, and stitch to create a scene of the environment. Thus, the system 300 may create pixel correspondence in a left warped RGB image and the fused image from multiple SLAM cameras to detect and fill the disocclusion.

In an exemplary embodiment, the system 300 may utilize the AI model to fill the artefact accurately and effectively. The AI model may be implemented over a cloud-storage associated with the system 300 and/or at the memory 410. The AI model may take the region of the artefact and the corresponding region in at least one of the SLAM image, as input. The AI model may also take a depth map or the depth of the scene/environment, as input and determine the depth of the artefacts corresponding to the region in the at least one SLAM image.

The AI model may enhance, fit, and fill the artefact region based on the received inputs. By enhancing, the AI model may align the characteristics of images i.e., the warped image and the SLAM image, as SLAM cameras may have lesser resolution as compared to the primary/passthrough camera devices. Further, the AI model may synthesize the view of the artefact's corresponding region in the at least one SLAM image to fit in the warped/passthrough image. In some embodiments, the AI model may also ensure smooth edges so that artefact region may blend perfectly.

Further, the AI model may be designed in a lightweight manner to limit the latency and ensure smooth operation of the system 300.

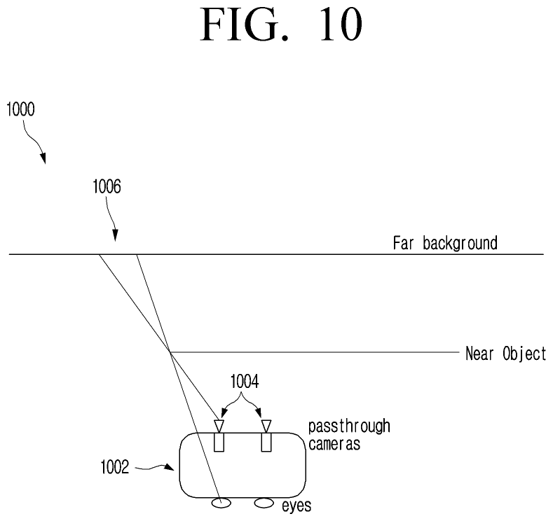

FIG. 10 illustrates an exemplary scenario of post-processing by a VST device 1002, according to an embodiment of the present disclosure. The VST device 1002 may correspond to the VST device 302, as shown in FIG. 3. The VST device 1002 may include a pair of passthrough cameras 1004. In one embodiment, the pair of passthrough cameras 1004 correspond to the primary imaging devices 301. Further, a region 1006 may correspond to an area of the scene/environment that is in the field of view of the eyes of the user, however, does not fall within the field of the passthrough cameras 1004. The system 300 may utilize the SLAM cameras to fill the region 1006 (i.e., the artefact). However, if there is no SLAM camera available to fill the region 1006, the system 300 may utilize the inpainting technique to fill the region 1006 during the post-processing step.

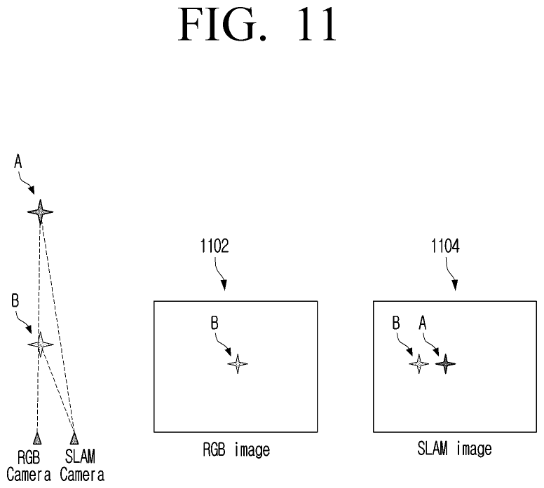

FIG. 11 illustrates an exemplary scenario of an importance of depth estimation, according to an embodiment of the present disclosure. FIG. 11 illustrates that an object “A” and an object “B” may be placed in an environment in such a manner that the RGB image 1102 may only include the object B, as the object A may be occluded, and the SLAM image 1104 may include both the object A and the object B at a different position at a 2D plane. Thus, the system 300 may perform depth estimation to accurately identify the position of the object A and object B in a 3-D space and use said information to fill the artefacts.

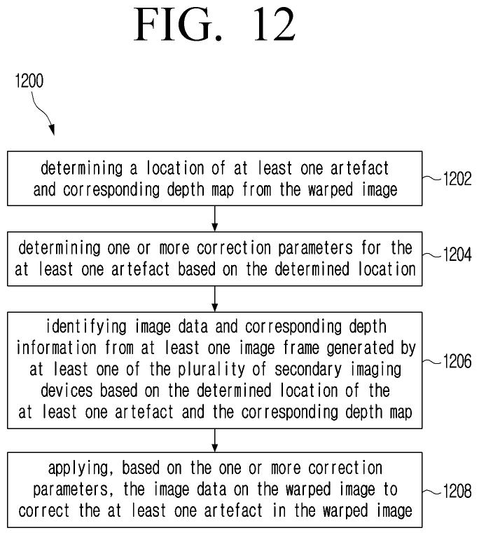

FIG. 12 illustrates a flow chart depicting a method 1200 for artefact correction of the warped image in the VST device 302, according to an embodiment of the present disclosure. The method 1200 may be implemented by the system 300 and/or the VST device 302, as explained in reference to FIGS. 1-11.

At step 1202, the method 1200 may include determining a location of at least one artefact and a corresponding depth map from the warped image. The warped image may be generated from a plurality of image frames captured by the plurality of primary imaging devices 301. In some embodiments, to determine the location of the at least one artefact, the method 1200 may include identifying a plurality of blank pixels and corresponding position coordinates in the warped image. The method 1200 may further include classifying the plurality of blank pixels as the at least one artefact. The method 1200 may further include determining the location of the at least one artefact based on the position coordinates of the plurality of blank pixels.

At step 1204, the method 1200 may include determining one or more correction parameters for the at least one artefact based on the determined location.

At step 1206, the method 1200 may include identifying image data along with corresponding depth information from at least one image frame generated by at least one of the plurality of secondary imaging devices 303 based on the determined location of the at least one artefact and the corresponding depth map. The method 1200 may include identifying at least a region of the at least one of the image frame based on the determined location of the at least one artefact in the warped image and the one or more correction parameters. The method 1200 may include receiving a plurality of image frames captured by the plurality of secondary imaging devices 303. The method 1200 may further include selecting the at least one image frame from the plurality of image frames based on the determined location of the artefact and the one or more correction parameters. Thereafter, the method 1200 may include identifying the image from the selected at least one image frame. In some embodiments, the method 1200 may include selecting at least one of the plurality of secondary imaging devices based on the determined location of the artefact and the one or more correction parameters and identifying the image data from the at least one image frame captured by the selected at least one of plurality of secondary imaging devices 303.

In one embodiment, the method 1200 may further include modifying the image data based on the one or more correction parameters. The one or more correction parameters may include at least one of a resolution, a sharpness, a colour, and a luma component.

At step 1208, the method 1200 may include applying, based on the one or more correction parameters, the image data on the warped image to correct the at least one artefact in the warped image. In some embodiments, the method 1200 may also include fusing the image data from the one or more image frames with the warped image to generate a scene at the determined location of the at least one artefact.

While the above-discussed steps in FIG. 12 are shown and described in a particular sequence, the steps may occur in variations to the sequence in accordance with various embodiments.

The present disclosure may enable the effective and efficient artefact correction of a warped image in a VST device. The present disclosure may use SLAM cameras to enable accurate filling of the disocclusions in the warped image. Further, the present disclosure may use a lightweight AI model that reduces latency and enhances the overall performance of the system.

The above-described methods according to at least some of various embodiments of the present disclosure may be implemented in a form of application that may be installed in the existing electronic apparatus (or display apparatus).

In addition, the above-described methods according to at least some of various embodiments of the present disclosure may be implemented only by software upgrade or hardware upgrade of the existing electronic apparatus.

Further, the above-described methods according to at least some of various embodiments of the present disclosure can also be performed through an embedded server included in the electronic apparatus (or display apparatus) or an external server of at least one of the electronic apparatus.

Various embodiments described above may be implemented by software including instructions stored in a machine-readable storage medium (for example, a computer-readable storage medium). A machine is a device capable of calling a stored instruction from a storage medium and operating according to the called instruction, and may include the electronic apparatus (for example: electronic apparatus) of the disclosed embodiments. In the case in which a command is executed by the processor, the processor may directly perform a function corresponding to the command, or other components may perform the function corresponding to the command under a control of the processor. The instruction may include codes created or executed by a compiler or an interpreter. The machine-readable storage medium may be provided in a form of a non-transitory storage medium. Here, the “non-transitory storage medium” means that the storage medium is a tangible device, and does not include a signal (for example, electromagnetic waves), and the term does not distinguish between the case where data is stored semi-permanently on a storage medium and the case where data is temporarily stored thereon. For example, the “non-transitory storage medium” may include a buffer in which data is temporarily stored. According to an embodiment, the methods according to various embodiments disclosed in the present document may be included and provided in a computer program product. The computer program product may be traded as a product between a seller and a purchaser. The computer program product may be distributed in the form of a machine-readable storage medium (for example, compact disc read only memory (CD-ROM)), or may be distributed (for example, download or upload) through an application store (for example, Play Store™M) or may be directly distributed (for example, download or upload) between two user devices (for example, smartphones) online. In a case of the online distribution, at least some of the computer program products (for example, downloadable app) may be at least temporarily stored in a machine-readable storage medium such as a memory of a server of a manufacturer, a server of an application store, or a relay server or be temporarily created.

Various embodiments of the present disclosure may be implemented by software including instructions stored in a machine-readable storage medium (for example, a computer-readable storage medium). A machine is a device capable of calling a stored instruction from a storage medium and operating according to the called instruction, and may include the electronic apparatus (for example: electronic apparatus) of the disclosed embodiments.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. A method of artefact correction of a warped image in a video see through (VST) device comprising a plurality of primary imaging devices and a plurality of secondary imaging devices, the method comprising:
determining a location of at least one artefact and a corresponding depth map from a warped image generated from a plurality of image frames captured by the plurality of primary imaging devices;
determining one or more correction parameters for the at least one artefact based on the determined location;
identifying image data and corresponding depth information from at least one image frame captured by at least one of the plurality of secondary imaging devices based on the determined location of the at least one artefact and the corresponding depth map; and
correcting the at least one artefact in the warped image by applying, based on the one or more correction parameters, the image data to the warped image.

2. The method as claimed in claim 1, further comprising:
prior to correcting the at least one artefact in the warped image, modifying the image data based on the one or more correction parameters,
wherein the one or more correction parameters comprise at least one of a resolution, a sharpness, a colour, and a luma component.

3. The method as claimed in claim 1, wherein the identifying the image data from the at least one image frame captured by the at least one of the plurality of secondary imaging devices comprises:
identifying at least one region from the at least one image frame based on the determined location of the at least one artefact in the warped image and the one or more correction parameters.

4. The method as claimed in claim 1, wherein the correcting the at least one artefact in the warped image comprises:
generating a scene at the determined location of the at least one artefact by fusing the image data from the at least one image frame with the warped image.

5. The method as claimed in claim 1, wherein the determining the location of the at least one artefact in the warped image comprises:
identifying a plurality of blank pixels and corresponding position coordinates in the warped image;
classifying the plurality of blank pixels as the at least one artefact; and
determining the location of the at least one artefact based on the position coordinates of the plurality of blank pixels. 6 The method as claimed in claim 1, wherein the identifying the image data from the at least one image frame captured by the at least one of the plurality of secondary imaging devices comprises:
receiving a plurality of image frames captured by the plurality of secondary imaging devices;
selecting the at least one image frame from the plurality of image frames based on the determined location of the at least one artefact and the one or more correction parameters; and
identifying the image data from the at least one image frame.

7. The method as claimed in claim 1, wherein the identifying the image data from the at least one image frame captured by the at least one of the plurality of secondary imaging devices comprises:
selecting at least one of the plurality of secondary imaging devices based on the determined location of the at least one artefact and the one or more correction parameters; and
identifying the image data from the at least one image frame captured by the at least one selected secondary imaging device.

8. A system for artefact correction of a warped image in a video see through (VST) device, the system comprising:
a plurality of primary imaging devices;
a plurality of secondary imaging devices;
a memory storing instructions; and
at least one processor communicably coupled with the memory,
wherein, by executing the instructions stored on the memory, the at least one processor is configured to:
determine a location of at least one artefact and a corresponding depth map from a warped image generated from a plurality of image frames captured by the plurality of primary imaging devices;
determine one or more correction parameters for the at least one artefact based on the determined location;
identify image data and corresponding depth information from at least one image frame captured by at least one of the plurality of secondary imaging devices based on the determined location of the at least one artefact and the corresponding depth map; and
correct the at least one artefact in the warped image by applying, based on the one or more correction parameters, the image data to the warped image.

9. The system as claimed in claim 8, wherein, in correcting the at least one artefact in the warped image, the at least one processor is configured to:
modify the image data based on the one or more correction parameters,
wherein the one or more correction parameters comprise at least one of a resolution, a sharpness, a colour, and a luma component.

10. The system as claimed in claim 8, wherein, in identifying the image data from the at least one image frame captured by the at least one of the plurality of secondary imaging devices, the at least one processor is configured to:
identify at least one region of the at least one image frame based on the determined location of the at least one artefact in the warped image and the one or more correction parameters.

11. The system as claimed in claim 8, wherein, in correcting the at least one artefact in the warped image, the at least one processor is configured to:
generate a scene at the determined location of the at least one artefact by fusing the image data from the at least one image frame with the warped image.

12. The system as claimed in claim 8, wherein, in determining the location of the at least one artefact in the warped image, the at least one processor is configured to:
identify a plurality of blank pixels and corresponding position coordinates in the warped image;
classify the plurality of blank pixels as the at least one artefact; and
determine the location of the at least one artefact based on the position coordinates of the plurality of blank pixels.

13. The system as claimed in claim 8, wherein, in identifying the image data from the at least one image frame captured by the at least one of the plurality of secondary imaging devices, the at least one processor is configured to:
receive a plurality of image frames captured by the plurality of secondary imaging devices;
select the at least one image frame from the plurality of image frames based on the determined location of the at least one artefact and the one or more correction parameters; and
identify the image data from the at least one image frame.

14. The system as claimed in claim 8, wherein, in identifying the image data from the at least one image frame captured by the at least one of the plurality of secondary imaging devices, the at least one processor is configured to:
select at least one of the plurality of secondary imaging devices based on the determined location of the at least one artefact and the one or more correction parameters; and
identify the image data from the at least one image frame captured by the at least one selected secondary imaging device.

15. A non-transitory computer-readable recording medium in which a program for executing an artefact correction method of a video see through (VST) device comprising a plurality of primary imaging devices and a plurality of secondary imaging devices, the artefact correction method comprising:
determining a location of at least one artefact and a corresponding depth map from a warped image generated from a plurality of image frames captured by the plurality of primary imaging devices;
determining one or more correction parameters for the at least one artefact based on the determined location;
identifying image data and corresponding depth information from at least one image frame captured by at least one of the plurality of secondary imaging devices based on the determined location of the at least one artefact and the corresponding depth map; and
correcting the at least one artefact in the warped image by applying, based on the one or more correction parameters, the image data to the warped image.

16. The system as claimed in claim 8, wherein the plurality of primary imaging devices comprise a plurality of red-green-blue (RGB) cameras,
wherein the plurality of secondary imaging devices comprise a plurality of simultaneous localization and mapping (SLAM) cameras, and
wherein, based on an arrangement of the plurality of SLAM cameras relative to the plurality of RGB cameras, the plurality of SLAM cameras are configured to capture a region not within a field of view of the plurality of RGB cameras.

17. The method as claimed in claim 1, further comprising:
determining the depth map including a depth value for a plurality of pixels from an image captured by one of the plurality of secondary imaging devices and corresponding to the warped image.

18. The system as claimed in claim 8, wherein the at least one processor is further configured to:
determine the depth map including a depth value for a plurality of pixels from an image captured by one of the plurality of secondary imaging devices and corresponding to the warped image.

19. The method as claimed in claim 1, wherein the identifying the image data from the at least one image frame captured by the at least one of the plurality of secondary imaging devices comprises:
identifying at least one region from the at least one image frame based on the determined location of the at least one artefact in the warped image and the one or more correction parameters, and
wherein the correcting the at least one artefact comprises:
generating a scene at the determined location of the at least one artefact by fusing the image data from the at least one image frame with the warped image.

20. The system as claimed in claim 8, wherein the at least one processor is further configured to:
identify at least one region of the at least one image frame based on the determined location of the at least one artefact in the warped image and the one or more correction parameters, and generate a scene at the at least one identified region by fusing the image data from the at least one image frame with the warped image.
